(19) United States
(12) Patent Application Publication
(10) Pub. No.: US 2004/0240464 A1
(43) Pub. Date: Dec. 2, 2004

(54) Method of transmitting data to reduce bit errors in communication systems

(76) Inventor: Wayne Charles Fite, Elmhurst, IL (US)

Correspondence Address: HARNESS, DICKEY & PIERCE, P.L.C., P.O. Box 8910, Reston, VA, 20195, US

(21) Appl. No.: 10/448,126

(22) Filed: May 30, 2003

(51) Int. Cl. H04L 12/40

(52) U.S. Cl. 370/438; 370/471

(57) ABSTRACT

A method of transmitting data so as to avoid bit errors in a communication system is described. In the method, overhead data of a data packet may be apportioned to a first set of bins, and payload data in the data packet may be apportioned to a second set of bins. The first set of bins may be transmitted over an overhead channel, and the second set of bins may be transmitted in a payload channel. In order to reduce bit errors in the payload, the first set of bins may be assigned a first signal to noise ratio (SNR) margin that exceeds a second SNR margin assigned to the second set of bins. Alternatively, additional forward error correction bytes may be assigned to the overhead channel, so that any errors cause only a payload bit to be corrupted, instead of an entire packet or cell.

### BACKGROUND OF THE INVENTION

1. Field of the Invention

The present invention generally relates to transmitting data so as to reduce bit errors in communication systems or networks such as Asymmetric Digital Subscriber Line (ADSL) systems.

2. Description of Related Art

Plain Old Telephone Service (POTS) is typically deployed to individual subscribers over a twisted pair of wire. Today, in addition to voice services, more and more subscribers want high-speed data access (i.e., to the Internet), over this twisted pair. One technology that increases the transmission capacity over a twisted pair is Asymmetric Digital Subscriber Loop (ADSL). One version of ADSL increases the bandwidth of the twisted pair up to 1.1 Mhz (megahertz), which provides transmission capabilities up to 9 Mbps (millions of bits per second). An ADSL modem may carry information up to 200 times faster than typical voice-band modems, which transmit up to about 56 kb/s over two-wire telephone line.

ADSL allocates different amounts of bandwidth between upstream communications and downstream communications (hence the term “asymmetric”), with upstream communications having less bandwidth than downstream communications. In this context, there are different strategies for specific bandwidth allocation and different modulation methods available. For example, in the upstream direction, i.e., from a subscriber's consumer premises equipment (CPE), also referred to as a ‘remote terminal’ (RT) to a central office (CO) the upstream channel may have an allocated bandwidth from about 25 Khz (kilohertz) to 138 Khz; while in the downstream direction, i.e., from the CO to the RT, the downstream channel may have an allocated bandwidth from about 138 Khz to 1.1 Mhz. The POTS voice channel (0 to 4 Khz) is unaffected by ADSL.

In this example, the upstream channel and downstream channel may be disjoint and also adjacent. However, ADSL systems may also be constructed where the upstream channel partially overlaps with the downstream channel. While this provides more bandwidth for the downstream signal, this also requires the use of echo cancellation techniques. Turning to modulation methods, carrier-less amplitude phase (CAP) modulation or Discrete Multi-Tone (DMT) modulation can be used. (DMT is a form of orthogonal frequency division multiplexing (OFDM).)

One standard for ADSL transmission is ANSI T1.413. This standard specifies the use of DMT modulation, which utilizes multiple carriers (also sometimes referred to as sub-carriers) for conveying information. In DMT modulation, the allocated frequency range may be divided into K carrier channels (K>1), also referred to as DMT ‘bins’. Each DMT bin (hereafter also referred to as ‘bin’) is separated by approximately 4 Khz (e.g., each bin (channel) has a width of 4.3125 kHz.). In other words, data may be separated so as to be transmitted across narrow channels (bins), with 256 possible downstream bins (0 . . . 255) and 32 possible upstream bins in which to carry bits of data. A goal of DMT is to achieve as close to Shannon capacity for communication systems such as xDSL, ADSL systems, etc. as possible, while equivalently maximizing the signal to noise ratio (SNR) in each bin.

In such an approach, a DMT-based ADSL system transmits what is referred to as multi-tone symbols or ‘DMT symbols’. A DMT symbol may be defined as a collection of complex values (Zᵢ) forming the frequency domain input to an Inverse Discrete Fourier Transform (IDFT) process implemented by a processor of an ADSL transceiver, for example, or alternatively a collection of real values xₙ forming the time domain output of the IDFT. One of these complex values is referred to as the aforementioned sub-carrier. DMT symbols may be sent with or without a cyclic prefix, which in ANSI T1.413 is a periodic extension of the time domain representation of the symbol, inserted at the transmitter portion of an ADSL transceiver, to avoid symbol distortion at a receiver portion of the ADSL transceiver.

ADSL uses a superframe structure (17 msec). Each superframe is composed of 68 ADSL data frames (each ADSL data frame has a period of 250 μs), numbered 0 to 67, which are encoded and modulated into 68 DMT data symbols, followed by a DMT synchronization symbol, which carries no user or overhead bit-level data and is inserted to establish superframe boundaries. The DMT symbol rate is 69/68×4000 symbols/sec, to account for the insertion of the DMT synchronization symbol. As is known, each ADSL data frame within the superframe contains data from a fast buffer and an interleaved buffer. The size of each buffer depends on the assignment of bearer channels made during an ADSL initialization sequence between the ADSL transceivers at the CO and RT. A bearer channel is a user data stream of a specified data rate that is transported transparently by an ADSL system in of the simplex bearer channels (ASx, x=0, 1, 2 or 3) or duplex bearer channels (LSx, x=0, 1 or 2).

Each bin may be used to transmit between 2-15 bits per ADSL frame. The number of bits a bin may carry is determined in the initialization sequence by estimating an ‘SNR margin’ for each bin. The SNR margin depends on the signal level seen by the receiver (i.e., the receiver portion of an ADSL transceiver at the RT), after being attenuated by the telephone loop (i.e., copper wire or copper line between CO and RT), and the noise level at the receiver, which may be caused by adjacent-line crosstalk and other disturbers. Currently, the SNR margin is set to a fixed +6 dB of fixed +3 dB by ANSI T1.413.

The transmitted bits in each bin may include ADSL system overhead and payload. Per ANSI T1.413, the ADSL system overhead includes an ADSL embedded operations channel (eoc), ADSL overhead control channel (aoc), cyclic redundancy code (crc) check bytes (a common error checking algorithm), fixed indicator bits (ib) for operations, administration and maintenance (OAM), Reed-Solomon forward error correction (RS FEC) redundancy bytes, plus cell and packet overhead. The payload is the net data rate (i.e., data rate available for user data in any one direction) transmitted in the ADSL bearer channels (ASx, LSx). The additional overhead is typically in a header of an ADSL packet or cell, in addition to cell or packet overhead which contains address or routing information for the cell or packet to be transmitted. A cell refers to an Asynchronous Transfer Mode (ATM) cell in a switching layer such as an ATM layer. The cell consists of 53 bytes: 5 bytes allocated to overhead and 48 bytes allocated for payload.

The SNR margin may degrade (decrease) as noise level increases. Noise may increase as more DSL lines become active in the same binder or trunk, for example. As the SNR margin decreases to zero and becomes negative, errors (CRC errors) begin to occur in the data transmission over an established link (line) between CO and RT. An ADSL modem (e.g., ADSL transceiver at one of the CO or RT) monitors these CRC errors to determine link quality, and either ADSL transceiver can initiate a ‘re-train’ to cause the modems to re-initialize, given the new line conditions (noise, attenuation, etc.)

Currently in an ADSL system or network, all data bits (overhead bits and payload bits) in the bins are subject to the same rate of bit errors (same BER) when the SNR margin degrades to zero or becomes negative. Thus, errors on an ADSL line may cause the ATM layer (and higher layers), which contain the overhead bits, to take errors at the same rate as the payload bits. When overhead bits take errors, cells or packets may be dropped or misrouted, causing a burst of data loss in the system or network. This may also be seen as a multiplication of bit errors in the ADSL system or network. In other words, if an entire packet or cell is lost due to misrouting/dropping, the bit errors may increase by a factor equal to 48 bytes (size of payload)×8 bits/byte, or 384 bits. Thus, the number of bit errors in the ADSL system or network is multiplied, disrupting service.

### SUMMARY OF THE INVENTION

Exemplary embodiments of the present invention are directed to a method of transmitting data in a communication system, where overhead data and payload data are transmitted over separate channels in an effort to reduce bit errors in the overhead which could cause misrouting or dropping of an entire packet or cell of data. In the method, overhead data of a data packet may be apportioned to a first set of bins, and payload data in the data packet may be apportioned to a second set of bins. The first set of bins may be transmitted over an overhead channel, and the second set of bins may be transmitted in a payload channel. In order to reduce bit errors in the payload, the first set of bins may be assigned a first signal to noise ratio (SNR) margin that exceeds a second SNR margin assigned to the second set of bins. Alternatively, additional forward error correction bytes may be assigned to the overhead channel, so that any errors cause only a payload bit to be corrupted, instead of an entire packet or cell.

### BRIEF DESCRIPTION OF THE DRAWINGS

Exemplary embodiments of the present invention will become more fully understood from the detailed description given herein below and the accompanying drawings, wherein like elements are represented by like reference numerals, which are given by way of illustration only and thus do not limit the exemplary embodiments of the present invention and wherein:

FIG. 1 illustrates a high-level block diagram of an ADSL architecture, in accordance with an exemplary embodiment of the invention.

FIG. 2 is a block diagram illustrating an ADSL transceiver in accordance with an exemplary embodiment of the invention.

FIG. 3 is a more detailed block diagram of the DMT Tx Core/DMT Rx Core in FIG. 2.

FIG. 4 is a timing diagram illustrating an initialization sequence in accordance with an exemplary embodiment of the invention.

FIG. 5 is a flow diagram illustrating a method of reducing bit errors in accordance with an exemplary embodiment of the invention.

FIG. 6 is a flow diagram illustrating a method of reducing bit errors in accordance with another exemplary embodiment of the invention.

### DETAILED DESCRIPTION OF EXEMPLARY EMBODIMENTS

Although the following description of the present invention is based on Asymmetric Digital Subscriber Line (ADSL) system or network infrastructure, it should be noted that the exemplary embodiments shown and described herein are meant to be illustrative only and not limiting in any way. As such, various modifications will be apparent to those skilled in the art. For example, it will be understood that the present invention finds application to any packet-based communication system or network in which packets carry overhead, including, but not limited to packet switched data networks (PSDNs) such as the Internet, systems implementing internet protocol (IP), and/or any xDSL system providing xDSL services (i.e., MDSL, HDSL, HDSL2, SDSL, VDSL, etc.)

Where used below, the terms remote terminal, subscriber, user, service user and remote station are synonymous and describe a remote user of resources in a communication network.

In general, the exemplary embodiments of the present invention introduce a method of transmitting data and methods to reduce bit errors in data transmissions across an ADSL, in order to provide efficient voice band services (including POTS and data services) and a variety of digital channels that include full-duplex low-speed bearer channels (LSx) and simplex high-speed bearer channels (ASx), in an effort to support the simultaneous transport of voiceband services and both simplex and duplex digital channels on a single twisted-pair.

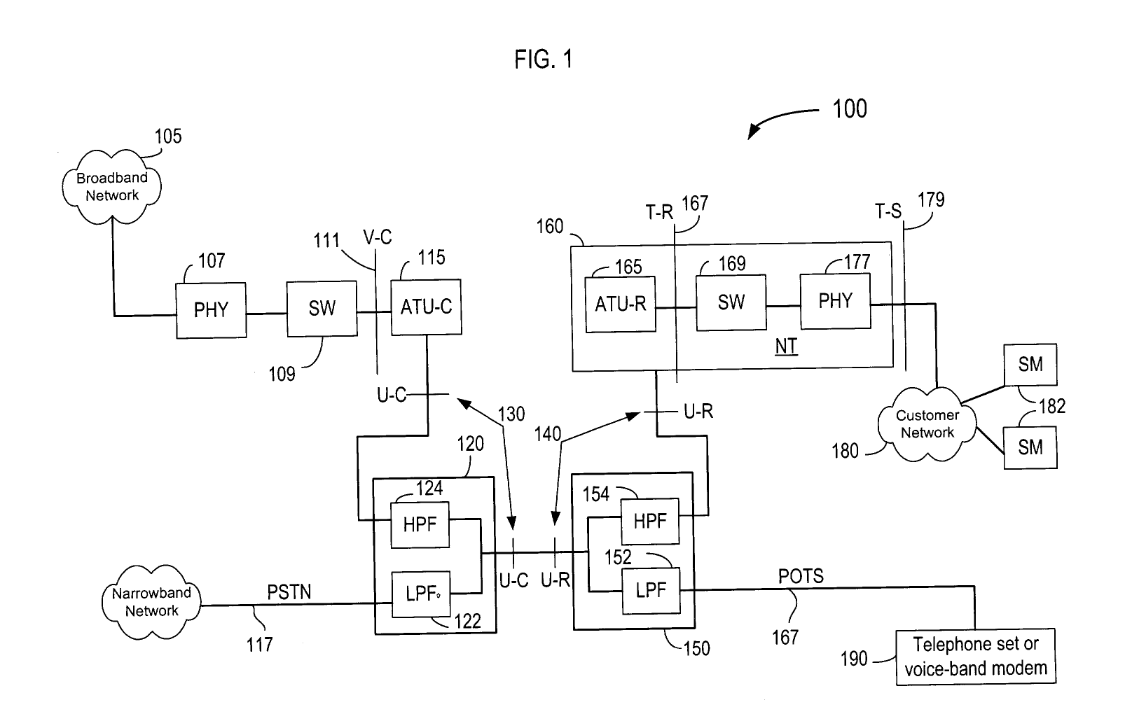

FIG. 1 illustrates a high-level block diagram of an ADSL architecture, in accordance with an exemplary embodiment of the invention. FIG. 1 illustrates the function blocks of an ADSL system 100 required to provide ADSL service. Referring to FIG. 1, a data stream from a broadband network 105 may be received via physical layer 107, if ADSL system 100 is configured for either of ATM transport or synchronous transport (STM). Alternatively, a splitter 120 may receive data signals from a narrowband network 115 via PSTN 117. ATM and STM are application options. In other words, an ADSL transceiver, Central Office end (ATU-C) 115 and/or ADSL transceiver, Remote Terminal end (ATU-R) 165 may be configured for either STM bit sync transport or ATM cell transport depending on whether the U-C interface 130 (loop interface at central office end) or U-R interface 140 (loop interface at remote terminal end) is ATM cell based or STM bit sync based, as described in ANSI T1.413, for example.

On the CO side, the data stream from physical layer 107 may be processed at switching layer 109 (which may be configured as an ATM or STM switching subsystem), into bearer channels, and the bearer channels (ASx, LSx) carrying the data are input, via V-C interface 111, to ATU-C 115. V-C interface 111 is a logical interface between ATU-C 115 and switching layer 109 (ATM or STM). The V-C interface 111 may consist of interfaces to one or more switching subsystems. As to be described in further detail, the data on the bearer channels may be multiplexed and synchronized into bits of an ADSL frame (which is one of 68 ADSL frames of a superframe) at the roughly 4 kHz ADSL frame rate, onto two paths (not shown in FIG. 1), a fast path and an interleaved path. Data on each path can undergo well known cyclic redundant check (CRC) error detecting, forward error correcting coding (FEC); and interleaving operations may be performed on the interleaver path.

As discussed above, bits in the ADSL frames are subject to DMT modulation, where the allocated frequency range is divided into bins separated by approximately 4 Khz (e.g., each bin (channel) has a width of 4.3125 kHz.). In other words, data may be separated so as to be transmitted across narrow channels (bins), with 256 possible downstream bins (0 . . . 255). In general, and as is known, bits are tone ordered to form complex amplitudes which are encoded and modulated into 68 DMT data symbols, followed by a DMT synchronization symbol. The DMT symbol is a collection of complex values (Zᵢ) forming the frequency domain input to an Inverse Discrete Fourier Transform (IDFT) process implemented by a processor of ATU-C 115, such as a digital signal processor (DSP) for example, or alternatively a collection of real values xₙ forming the time domain output of the IDFT. A series of buffers in the IDFT are loaded with data corresponding to the number of bits and amplitude for each sub-carrier (each one of the Zᵢ).

The output of the IDFT (real values xₙ) is a parallel data stream of real time samples in the time domain, which is converted to a serial stream by a serial buffer and processed by Digital to Analog Converter (DAC) using well-known techniques. The converted data is then sent via U-C interface 130 to splitter 120. Splitter 120 includes high pass filter (HPF) 124 and low pass filter (LPF) 122 that separate the high frequency signals (ADSL data frames of a superframe) from the voiceband signals (POTS signals and other voiceband signals) for out-of-band signal suppression. The separated signals may then be transmitted via the U-C interface 130 and U-R interface 140 to a remote terminal (represented as service modules 182).

These RT side is similar to the CO side, thus it is not explained in detail. The ADSL data frames are processed in ATU-R 165 of network termination 160 in reverse fashion, forwarded via a T-R interface 167 between the ATU-R 165 and switching layer 169, physical layer 177, then via a T/S interface 179 between the NT 160 and a user's home network 180, to service module 182. Concurrently, separated voice signals are transmitted over a POTS line 167 of the twisted pair to a telephone set or voiceband modem 190, as shown in FIG. 1.

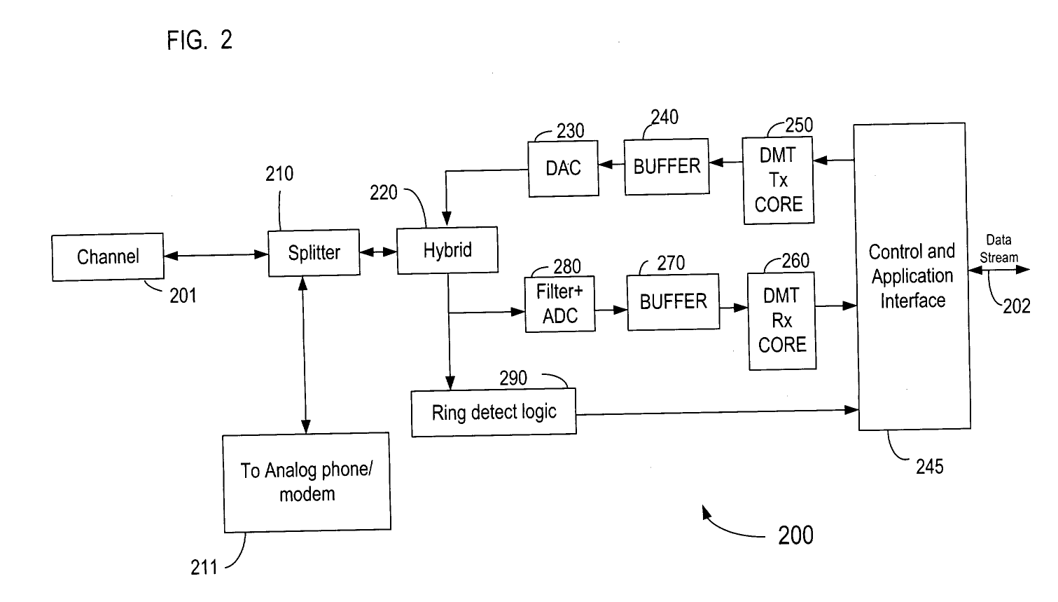

FIG. 2 is a block diagram illustrating an ADSL transceiver in accordance with an exemplary embodiment of the invention. The basic structure of an ADSL transceiver in which the exemplary embodiments of the present invention is employed is depicted generally in FIG. 2. This circuitry is well-known in the art, and can be implemented by skilled artisans in a variety of ways. The explanation of the structure and function of these remaining components of the ADSL transceiver 200 are given here primarily as background for understanding the context of the present invention, and it will be understood by those skilled in the art that these are only typical implementations of such components, and, more importantly, that the exemplary embodiments of present invention can be beneficially utilized as well in a wide variety of non-ADSL communications environments employing similar multi-carrier DMT technology.

In FIG. 2, transceiver 200 may represent ATU-C 115 or ATU-R 165 of FIG. 1, for example. In FIG. 2, transceiver 200 is connected via some channel 201 to a second transceiver (not shown). In ADSL applications, channel 201 is typically made of regular copper wire “loop”, and each such loop may have different electrical properties, transmission lengths (sizes), varying attenuation characteristics, and a number of impairments or interferences. It will be apparent to those skilled artisans, however, that the exemplary embodiments of the present invention can be used in conjunction with any number of different channel environments having different operating characteristics and associated impairments. Transceiver 200 may be located in a remote “downstream” remote terminal site, or at an “upstream” central office site.

At the other end of transceiver 200 is a Control and Application Interface 245, which is responsible for receiving and processing a high rate input bit data stream 202. This data stream 202 may originate from one or more data sources (broadband network 105, narrowband network 116, home network 180, WAN, LAN, host storage devices, etc.), and can include a variety of types of digital information, including data, video, control signals, etc. from various host computing devices, electronic libraries, Internet service providers, and high definition television broadcasters and similar sources.

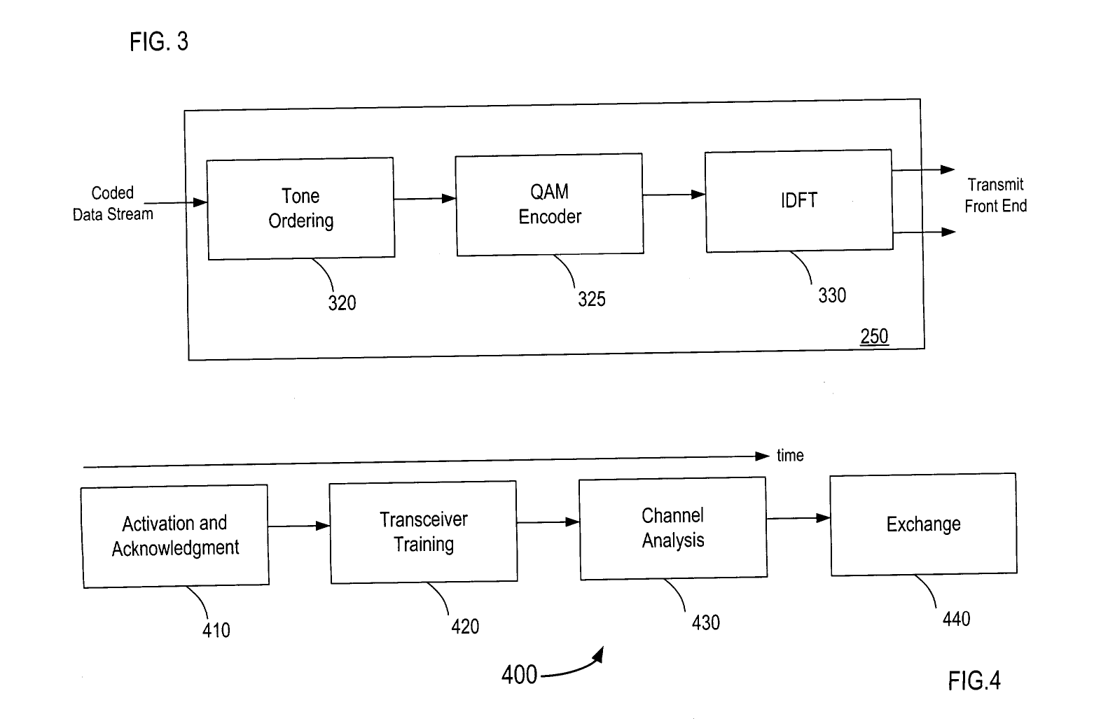

The encoded data stream may be processed by DMT Transmit (Tx) Core 250. DMT Tx Core 250 operates generally as follows. As shown in FIG. 3, a Tone Ordering circuit 320 allocates bits from an error encoded serial bit stream on one or more of a fast path and an interleaved path (not shown) at a given symbol rate T (equal to 246.38 ms in T1E1.413 standard), and a target bits/symbol (typically from about 100 to 1500), so that the serial bit stream is grouped in parallel over DMT bins. The fast path provides for low latency, the interleaved path provides low error rate and greater latency. An ADSL system supporting ATM transport support operation in a single latency mode, in which all user data is allocated tone path (fast or interleaved). Support of dual latency mode, in which user data is allocated to both paths, may be optional.

It is also known that the serial data stream 202 can undergo well known cyclic redundant check (CRC) error detecting, forward error correcting coding (FEC), and interleaving operations at DMT Tx Core 250 of transceiver 200, as discussed above, to improve the system 100 tolerance to various kinds of noise sources such as impulse noise and line cross-talk.

The output of Tone Ordering circuit 320 may be passed onto a constellation encoder such as a QAM encoder 325, again a conventional and well-known circuit, which produces complex amplitudes, representing a signal point in a constellation of signal points, scaled in accordance with the energy distribution appropriate for each bin bit allocation. A series of buffers in IDFT circuit 330 are loaded with data corresponding to the number of bits and amplitude for each bin.

For ADSL modulation based on the T1E1.413 standard, 255 bins using 255 separate frequencies spaced 1/T apart are allocated. After adding an additional baseband channel for voice transmissions, an IDFT may be used (256 complex points from QAM plus their 256 complex conjugates) to generate 512 real time-domain samples (xₙ, n=0 to 511). It will be apparent to skilled artisans that various modifications could be done to the above DMT Tx Core circuits for other multi-carrier systems.

To avoid inter-symbol interference due to the band-limited DSL channel, it is well known in the art of multi-carrier systems that a prefix can be added to the ordered data output of DMT Tx Core 250, which is the same as the last few IDFT output points. In the case of T1.413 standard, the prefix for downstream transmissions has a length of 32 and is called the cyclic prefix; the upstream prefix length is 4. After this, the parallel data stream is converted to a serial stream by buffer 240 and then processed by DAC 230 using well-known techniques. The converted data is then sent to appropriate filters of splitter 210 for out-of-band signal suppression, and/or first to a hybrid circuit 220 for duplex transmission coupling. As well-known in the art, a hybrid serves as an interface between telephone 2-wire lines and 4-wire lines, and consists primarily of filters, transformers, and isolation circuitry.

While not shown expressly here in the transmitter section, the exemplary embodiments of the present invention are also completely compatible with, and can be used in conjunction with a technique known in the art as Trellis Coding. Trellis code modulation (TCM) is an error correction coding scheme commonly used in multi-carrier systems to provide additional coding gains. In addition, echo-cancellation, another common feature of ADSL may also be advantageously employed with some systems incorporating the exemplary embodiments of the present invention.

The receiving side structure and operation are analogous to the transmission side of transceiver 200, and for that reason it will not be discussed in detail at this point. In brief, an analog data signal is received by splitter 210, which separates a DMT signal consisting of the 255 bins from the voice-band POTS analog signal. The latter signal can be used for simultaneous voice or conventional analog/ISDN modems. A ring detect logic circuit 290 can also be implemented using accepted techniques in some embodiments, to alert a Control Interface (not shown) to the existence of a received signal originating from another transceiver. The analog received signal may be filtered and converted to digital form by ADC 280 and stored in Buffer 270.

DMT Receiver Core 260 is generally responsible for monitoring and measuring the SNR of the bins falling within the frequency range passed by FILTER+ADC 280, and for extracting the original data stream from the numerous bins. This circuit is similar to DMT Tx Core 250, in that the “inverse” operations are performed on the received data stream to reconstruct the original serial data stream originating on the input side of the transceiver As such details are well-known in the art for ADSL applications, they will not be repeated here.

FIG. 4 is a timing diagram illustrating an initialization sequence in accordance with an exemplary embodiment of the invention. Referring to FIG. 4, an ADSL initialization sequence 400 is required in order to physically connect ATU-C 115 with ATU-R 165 to establish a communications link. Establishment may be initiated by either of the ATU-C 115 or ATU-R 165 via an activation and acknowledgment procedure 410. The ATU-C 115, after power-up or loss of signal, and an optional self-test, may transmit activation tones and await a response from ATU-R 165. if no response is received after two attempts, the ATU-C 115 may wait for an activation request from the ATU-R 165 or an instruction from the network (CO) to retry. The ATU-C 165, after power-up or loss of signal, and an optional self-test, may repeatedly transmit activation requests and await a response from ATU-R 115.

In order to maximize throughput and reliability of the communication link, ADSL transceivers determine certain relevant attributes of the connecting channel (copper wire) and establish transmission and processing characteristics suitable to that channel. In FIG. 4, each receiver can determine and establish relevant attributes of the channel through a transceiver training procedure 420 and a channel analysis procedure 430. During an exchange process 440, each transceiver shares with its corresponding far-end transmitter certain transmission settings that it expects to see. Each receiver communicates to its far-end transmitter the number of bits and relative power levels to be used for each DMT bin, as well as any messages and final data rate information. These settings may be based on results obtained through the transceiver training and channel analysis procedures 420, 430, for example.

Details of each of the procedures are discussed in Chapter 9 of ANSI T1-413 and are not discussed in detail here, other than the channel analysis procedure 430 for the ATU-C 115 for downstream transmission of data. The ATU-C 115 generates several different signals in time sequence during channel analysis procedure 430, one signal of which is referred to as a C-MSGS1, which is a 48-bit message signal transmitted to the ATU-R 165. This message may include the vendor identification, ATU-C 115 transmit power used, echo canceling option (if applicable), modulation (e.g., trellis coding) option, framing structure, etc., and a minimum required SNR margin. The minimum required SNR margin is a positive number of dB (binary coded 0-15 dB). As discussed above, each DMT bin (i.e., “bin”) may be used to transmit between 2-15 bits per ADSL frame. The number of bits a bin may carry is determined in the initialization sequence by estimating an ‘SNR margin’ for each bin. The SNR margin depends on the signal level seen by the receiver (i.e., the receiver portion of an ADSL transceiver at the RT), after being attenuated by the telephone loop (i.e., copper wire or copper line between CO and RT), and the noise level at the receiver, which may be caused by adjacent-line crosstalk and other disturbers. Currently, the SNR margin is set to a fixed +6 dB by ANSI T1.413. In other words, each bin is assigned a fixed +3 dB or +6 dB margin; this SNR margin is communicated in the C-MSGS1 message sent downstream to the ATU-R 165, and is the same for DMT bins containing overhead bits as well as for bins containing payload bits. Accordingly, the exemplary embodiments of the present invention apportions overhead bits and payload bits into separate ‘overhead bins’ and ‘payload bins’, and may assign different SNR margins to a particular bin based on whether the DMT bin contains overhead bits or payload bits. This may be done during the initialization procedure, such as during channel analysis procedure 430, for example, although the present invention envisions the apportioning of bins and assigning of SNR margin to be performed at other time points in the initialization sequence 400 and/or during processing of ADSL frames in one of ATU-C 115 and ATU-R 165, for example.

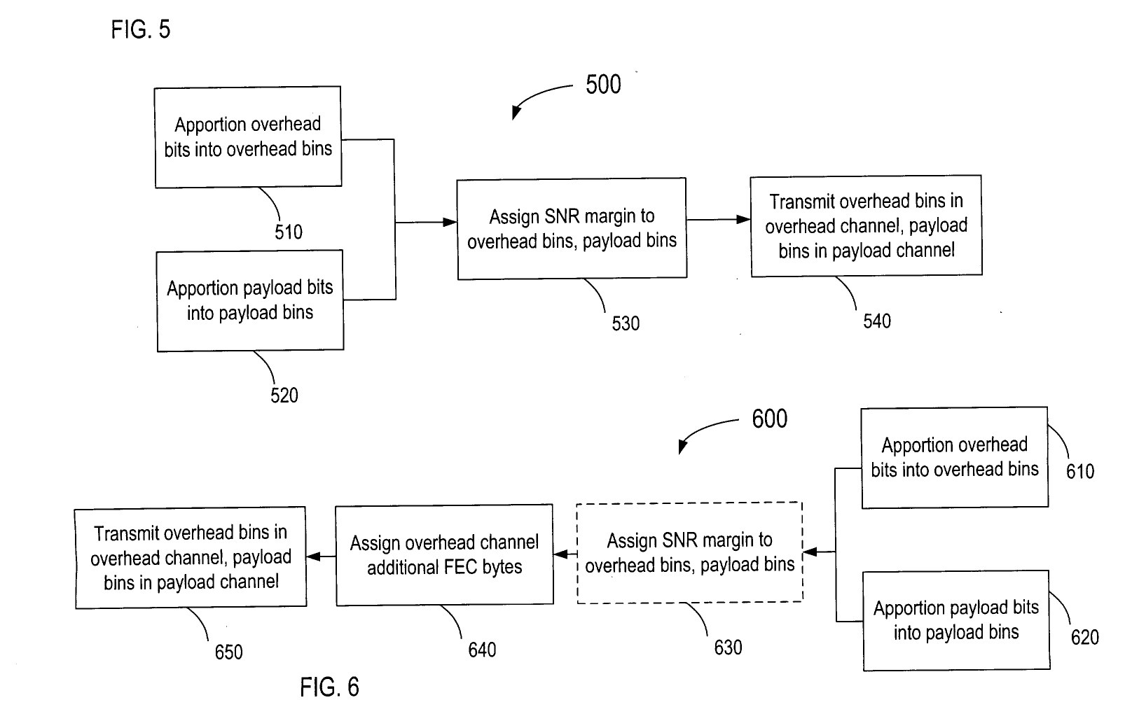

FIG. 5 is a flow diagram illustrating a method of transmitting a data stream so as to reduce bit errors in a communication system such as ADSL system 100, in accordance with an exemplary embodiment of the invention. Referring to FIG. 5, in the method 500, overhead bits may be apportioned (function 510) into bins designated for transmission in a new, dedicated overhead channel. Additionally, payload bits may be apportioned (function 520) into ‘payload bins’ to be transmitted over separate payload channels (i.e., bearer channels ASx, LSx).

The overhead data may include ADSL embedded operations channel (eoc) bits, ADSL overhead control channel (aoc) bits, cyclic redundancy code (crc) check bytes (a common error checking algorithm), fixed indicator bits (ib) for operations, administration and maintenance (OAM) and Reed-Solomon forward error correction (RS FEC) redundancy bytes, in addition to the cell or packet overhead. The cell or packet overhead may typically be in higher SNR overhead bins than the ADSL overhead. These higher SNR bins may also include the ADSL overhead, however. The eoc bits may be used for in-service and out-of service maintenance and for the retrieval of a specified amount of ATU-R 165 status information and ADSL performance monitoring parameters, as specified in ANSI T1.413. The aoc bits contain control information such as vendor specific data, reconfiguration data, bit swap request and bit swap acknowledgment data, for example.

Bit errors in the overhead data may be more critical than bit errors in payload data bits, since cell or packet overhead data typically contains the routing, addressing and termination information for a cell or packet. Accordingly, the SNR margin field in the C-MSGS1 message transmitted during initialization with the ATU-R 165 may include bits indicating, or assigning (function 530) the minimum required SNR margin for the overhead bins, or overhead bits to be transmitted on the overhead channel, as well as a minimum required SNR margin for the payload bins, or payload bits to be transmitted on the bearer (payload) channels, for example. Since the overhead bits may contain more critical information, a higher SNR margin may be assigned to those bins, as compared to the SNR margin assigned to the payload bins. The overhead bins, with higher SNR margin, are thus transmitted (function 540) over the overhead channel and the payload bins are transmitted over the payload channel(s). Accordingly, since the overhead bins are assigned a higher SNR margin, there is a lesser likelihood that the overhead bins suffer bit errors in transmission, even as the noise level increases due to cable attenuation and crosstalk. Moreover, a successful transmission may be made even with bit errors in bits of one or more payload bins, since the routing and addressing information in the overhead bins is unaffected.

Further, certain bits in the 48-bit C-MSGS1 which are not currently assigned may be assigned with information indicating which bins are overhead bins and which bins are payload bins. Still further, for bits not currently assigned in the current R-MSGS1 message to the ATU-C 115, ATU-R 165 may request a minimum required SNR margin for the overhead bins and a minimum required SNR margin for the payload bins.

FIG. 6 is a flow diagram illustrating a method of reducing bit errors in accordance with another exemplary embodiment of the invention. FIG. 6 is similar to FIG. 5, thus only the differences are discussed in detail. In addition to assigning different SNR margins, or in the alternative, the overhead channel may be assigned additional forward error correction bytes during initialization. In particular this may be done during the channel analysis procedure 430. When the ATU-C 115 transmits the C-MSGS1 message, the message includes a coding option. This coding option, or other bits in the message currently unassigned by the standard, may include additional forward error correction bytes allocated to the overhead channel, and hence to the bins containing the overhead bits. Accordingly, since the overhead bins are assigned additional FEC bytes, there is a lesser likelihood that the overhead bins suffer bit errors in transmission, even as the noise level increases due to cable attenuation and crosstalk. Moreover, a successful transmission may be made even with bit errors in bits of one or more payload bins, since the routing and addressing information in the overhead bins may be unaffected due to the additional FEC bytes. Additional FEC bytes may also be added to the overhead channels and payload channels at the same time. The additional FEC bytes may be calculated during channel analysis and inserted in the ADSL frame, for example.

The exemplary embodiments of the invention being thus described, it will be obvious that the same may be varied in many ways. Such variations are not to be regarded as departure from the spirit and scope of the exemplary embodiments of the invention, and all such modifications as would be obvious to one skilled in the art are intended to be included within the scope of the following claims.

What is claimed is:

1. A method of transmitting data in a communication system, comprising:
transmitting overhead data and payload data over separate channels.

2. The method of claim 1, wherein said transmitting includes transmitting said overhead data in an overhead channel and said payload data in a payload channel.

3. The method of claim 2, further comprising:
assigning additional forward error correction bytes to said overhead channel.

4. The method of claim 1, further comprising:
apportioning said overhead data to a first set of bins and said payload data to a second set of bins.

5. The method of claim 4, wherein said transmitting includes transmitting said first set of bins in an overhead channel and said second set of bins in a payload channel.

6. The method of claim 4, wherein said first set of bins and said second set of bins are Discrete Multi-tone Modulation (DMT) bins.

7. The method of claim 4, further comprising:
assigning said first set of bins a first signal to noise ratio (SNR) margin and said second set of bins a second SNR margin.

8. The method of claim 7, wherein said first SNR margin exceeds said second SNR margin.

9. The method of claim 8, wherein said transmitting includes transmitting said first set of bins in an overhead channel and said second set of bins in a payload channel.

10. The method of claim 1, wherein said communication system is an Asymmetric Digital Subscriber Line (ADSL) system.

11. The method of claim 1, wherein said communication system is at least one of a packet switched data network (PSDN) and an xDSL system.

12. A method of reducing bit errors when transmitting a data packet in a communication system, comprising:
apportioning overhead data in said data packet to a first set of bins and payload data in said data packet to a second set of bins; and
transmitting said first set of bins in an overhead channel and said second set of bins in a payload channel.

13. The method of claim 12, further comprising:
assigning said first set of bins a first signal to noise ratio (SNR) margin and said second set of bins a second SNR margin.

14. The method of claim 13, wherein said first SNR margin exceeds said second SNR margin.

15. The method of claim 12, wherein said communication system is an Asymmetric Digital Subscriber Line (ADSL) system.

16. The method of claim 12, wherein said communication system is at least one of a packet switched data network (PSDN) and an xDSL system.

17. A method of configuring a data packet for transmission with reduced bit errors in a communication system, comprising:
apportioning overhead data in said data packet to a first set of bins and payload data in said data packet to a second set of bins, said first set of bins to be transmitted in an overhead channel and said second set of bins to be transmitted in a separate payload channel, and
assigning additional forward error correction bytes to said overhead channel.

18. The method of claim 17, wherein said communication system is an Asymmetric Digital Subscriber Line (ADSL) system.

19. The method of claim 17, wherein said communication system is at least one of a packet switched data network (PSDN) and an xDSL system.
